(19) United States
(12) Patent Application Publication
(10) Pub. No.: US 2010/0153855 A1
(43) Pub. Date: Jun. 17, 2010

(54) Communication Management

(75) Inventors: Brian F. Roberts, Dallas, TX (US); Jayson D. Sellers, Carrollton, TX (US); Heath Stallings, Colleyville, TX (US); Donald H. Relyea, Dallas, TX (US); Kristopher T. Frazier, Frisco, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES LLC, Temple Terrace, FL (US)

(21) Appl. No.: 12/335,941

(22) Filed: Dec. 16, 2008

(51) Int. Cl. G06F 3/048; G06F 15/16

(52) U.S. Cl. 715/752; 715/764

(57) ABSTRACT

A method may include receiving a communication thread and identifying at least some items of interest in the communication thread. The method may also include displaying the communication thread with the identified items of interest being highlighted or displayed in a different manner than other portions of the communication thread.

### BACKGROUND INFORMATION

Text-based communications, such as electronic mail (email), text messages and instant messages (IMs), have become an increasingly common part of every day life. For example, in the work place, email is frequently used to discuss work-related issues. Friends and/or family members also exchange emails during the course of the day to discuss personal issues. Typically, an original email or other text-based communication results in a number of further communications between the party receiving the original communication and the party sending the original communication. These types of communications or “conversations” involving multiple emails or IMs involving one or more topics are typically referred to as threads.

Often, a party who is not part of an email thread, must be added or “looped into” a thread that includes several earlier emails on a particular topic. The emails that are part of the thread are forwarded to the party being looped into the thread and to everyone else in the thread, to let everyone in the thread know that a new party is being looped into the thread. The emails in the thread are usually displayed in reverse chronological order, with the most recent email being displayed first or highest in the list of emails. The party being looped into the thread is often unable to easily obtain the gist of the earlier exchanges. For example, the party being looped into the thread must go through the earlier emails to attempt to obtain the gist of the conversation. This process is usually time consuming and cumbersome.

### BRIEF DESCRIPTION OF THE DRAWINGS

FIG. 1 illustrates an exemplary network in which systems and methods described herein may be implemented;

FIG. 2 illustrates an exemplary configuration of a user device or network device of FIG. 1;

FIG. 3 illustrates an exemplary configuration of logic components implemented in the device of FIG. 2;

FIG. 4 illustrates an exemplary user interface provided by the conversation display program of FIG. 3;

FIG. 5 is a flow diagram illustrating exemplary processing associated with selecting display-related options for received communications;

FIG. 6 is a flow diagram illustrating exemplary processing associated with displaying communication-related information;

FIGS. 7A-7C illustrate a conventional email thread displayed to a user; and

FIGS. 8A and 8B illustrate exemplary output associated with processing performed by the conversation display program of FIG. 3.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to managing communications and displaying communications in a user-friendly manner. For example, when a party is being looped into a communication thread, relevant portions of the earlier conversation may be provided to the party being looped into the thread. In some implementations, the portions of the earlier conversation may be highlighted, while other portions of the earlier conversation may be eliminated. This may allow the party being looped into the thread to quickly obtain the gist of the earlier conversation. In some implementations, users involved in a thread and/or an algorithm executed by devices sending and/or receiving the communications may rank the most relevant messages or snippets of messages. The party being looped into the thread may be provided with the ranked messages to allow the party to view the messages in accordance with what the users deem important. Alternatively or additionally, the party being looped into the thread may set his/her own preferences with respect to displaying relevant portions of a thread. In addition, in some implementations, another party may be looped into a thread without having to send the entire thread to all the parties already included in the thread.

The terms “thread” and “communication thread” as used herein should be construed to include any electronic discussion or conversation involving multiple communications and/or multiple parties. For example, a thread may include a number of text-based communications between multiple parties regarding one or more topics. In addition, a thread may include multimedia-based discussions that include text, image/video and/or voice data that is communicated between multiple parties.

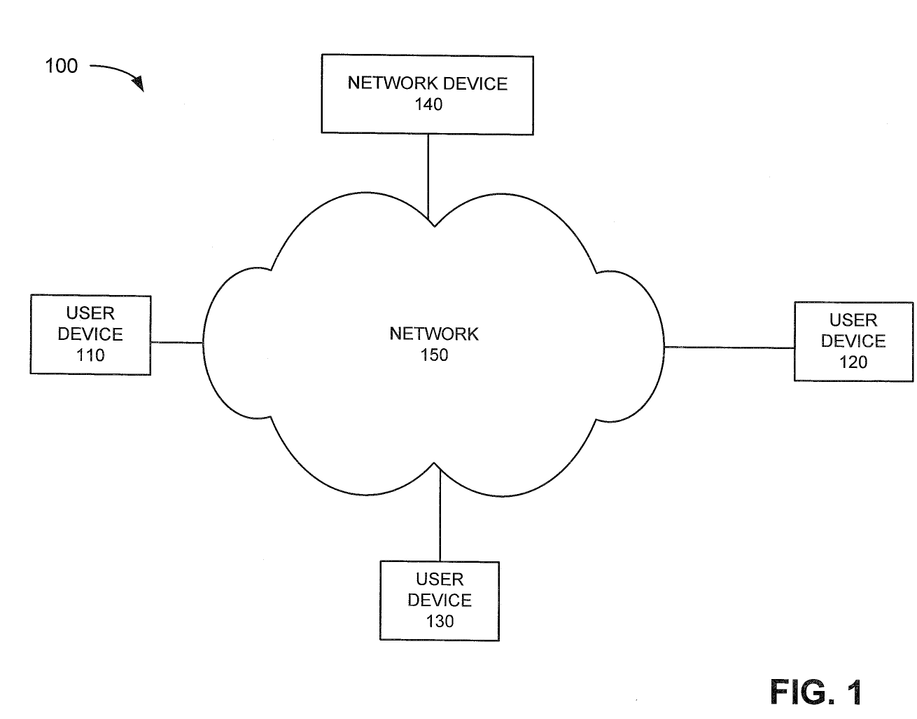

FIG. 1 is a block diagram of an exemplary network 100 in which systems and methods described herein may be implemented. Network 100 may include user devices 110, 120 and 130, network device 140 and network 150.

Each of user devices 110-130 may include any device or combination of devices capable of transmitting data and/or voice signals to a network, such as network 150. In one implementation, user devices 110-130 may include any type of communication device, such as a personal computer (PC), a laptop, a personal digital assistant (PDA), a wireless or cellular telephone (e.g., a personal communications system (PCS) terminal that may combine a cellular radiotelephone with data processing and data communications capabilities, a PDA that can include a radiotelephone, or the like) that can communicate via text-based messaging (e.g., email, text messages, IMs, etc.) and/or multimedia messaging that includes text, voice and/or image/video data. User devices 110-130 may connect to network 150 via any conventional technique, such as wired, wireless, or optical connections.

Network device 140 may include one or more computing devices, such as one or more servers, computers, etc., used to receive information from other devices in network 100. For example, network device 140 may receive information associated with a text-based or multimedia-based conversation between various parties associated with user devices 110-130, as described in detail below.

Network 150 may include one or more wired and/or wireless networks that are capable of receiving and transmitting data, voice and/or video signals, including multimedia signals that include text, voice and image/video information. For example, network 150 may include one or more public switched telephone networks (PSTNs) or other type of switched network. Network 150 may also include one or more wireless networks and may include a number of transmission towers for receiving wireless signals and forwarding the wireless signals toward the intended destinations. Network 150 may further include one or more packet switched networks, such as an Internet protocol (IP) based network, a local area network (LAN), a wide area network (WAN), a personal area network (PAN), an intranet, the Internet, or another type of network that is capable of transmitting data.

The exemplary configuration illustrated in FIG. 1 is provided for simplicity. It should be understood that a typical network may include more or fewer devices than illustrated in FIG. 1. For example, network 100 may include additional elements, such as switches, gateways, routers, etc., that aid in routing traffic, such as text-based or multimedia-based communications, from user devices 110-130 to their respective destinations in network 100. In addition, although user devices 110-130 and network device 140 are shown as separate devices in FIG. 1, in other implementations, the functions performed by multiple ones of user devices 110-130 and network device 140 may be performed by a single device. In still other implementations, the functions performed by one device may be performed by another device. For example, in some implementations, the functions described as being performed by one of user devices 110-130 may be performed by network device 140.

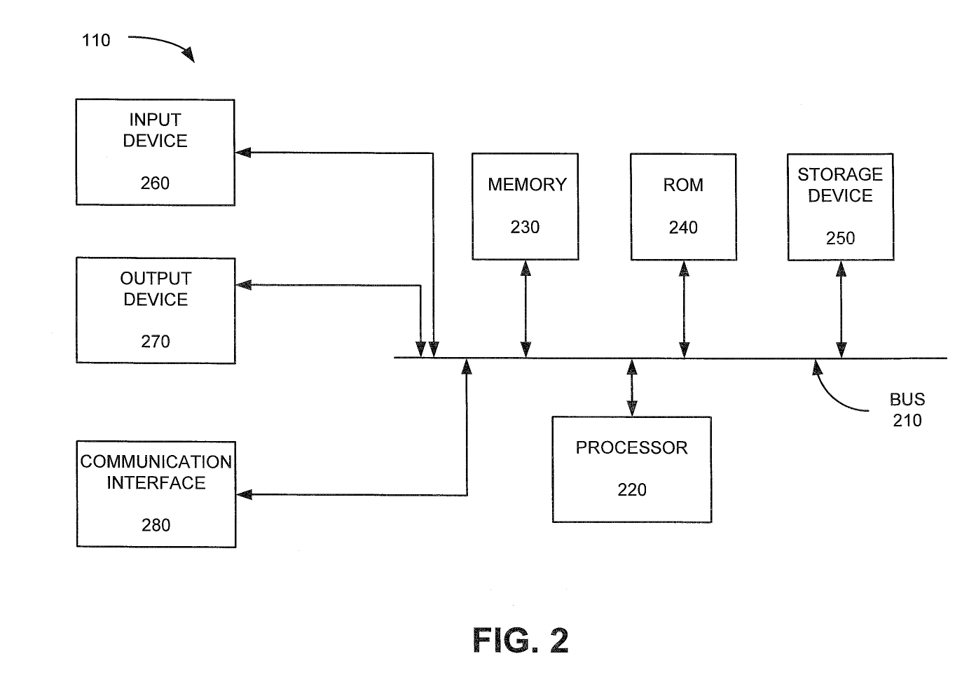

FIG. 2 is a diagram illustrating components of user device 110 according to an exemplary implementation. User devices 120 and 130 and network device 140 may be configured in a similar manner. Referring to FIG. 2, user device 110 may include bus 210, processor 220, main memory 230, read only memory (ROM) 240, storage device 250, input device 260, output device 270, and communication interface 280. Bus 210 may include a path that permits communication among the elements of user device 110. It should be understood that user device 110 may be configured in a number of other ways and may include other or different elements.

Processor 220 may include one or more processors, microprocessors, application specific integrated circuits (ASICs), field programmable gate arrays (FPGAs), or other processing logic that may interpret and execute instructions. Memory 230 may include a random access memory (RAM) or another type of dynamic storage device that may store information and instructions for execution by processor 220. ROM 240 may include a ROM device or another type of static storage device that may store static information and instructions for use by processor 220. Storage device 250 may include a magnetic and/or optical recording medium and its corresponding drive.

Input device 260 may include one or more mechanisms that permit a user to input information to user device 110, such as a keyboard, a microphone, a touch screen, a mouse, a pen, voice recognition and/or biometric mechanisms, etc.

Output device 270 may include one or more mechanisms that output information to the user, including a display, such as a liquid crystal display (LCD), a printer, one or more speakers, etc.

Communication interface 280 may include any transceiver-like mechanism that user device 110 may use to communicate with other devices (e.g., user devices 120/130 or network device 140) and/or systems. For example, communication interface 280 may include mechanisms for communicating via network 150, which may include a wireless network. In these implementations, communication interface 280 may include one or more radio frequency (RF) transmitters, receivers and/or transceivers and one or more antennas for transmitting and receiving RF data via network 150. Communication interface 280 may also include a modem or an Ethernet interface to a LAN. Alternatively, communication interface 280 may include other mechanisms for communicating via a network, such as network 150.

User device 110 may perform processing associated with displaying, sending and receiving text-based messages or multimedia-based messages, such as email messages, text messages, IMs, mobile IMs (MIMs), short message service (SMS) messages, multimedia messages with text, image/video and/or voice data, etc., in a user-friendly format. User device 110 may perform these operations in response to processor 220 executing sequences of instructions contained in a computer-readable medium, such as memory 230. A computer-readable medium may be defined as a physical or logical memory device. The software instructions may be read into memory 230 from another computer-readable medium (e.g., a hard disk drive, solid state drive, etc.), or from another device via communication interface 280. Alternatively, hard-wired circuitry may be used in place of or in combination with software instructions to implement processes consistent with the implementations described herein. Thus, implementations described herein are not limited to any specific combination of hardware circuitry and software.

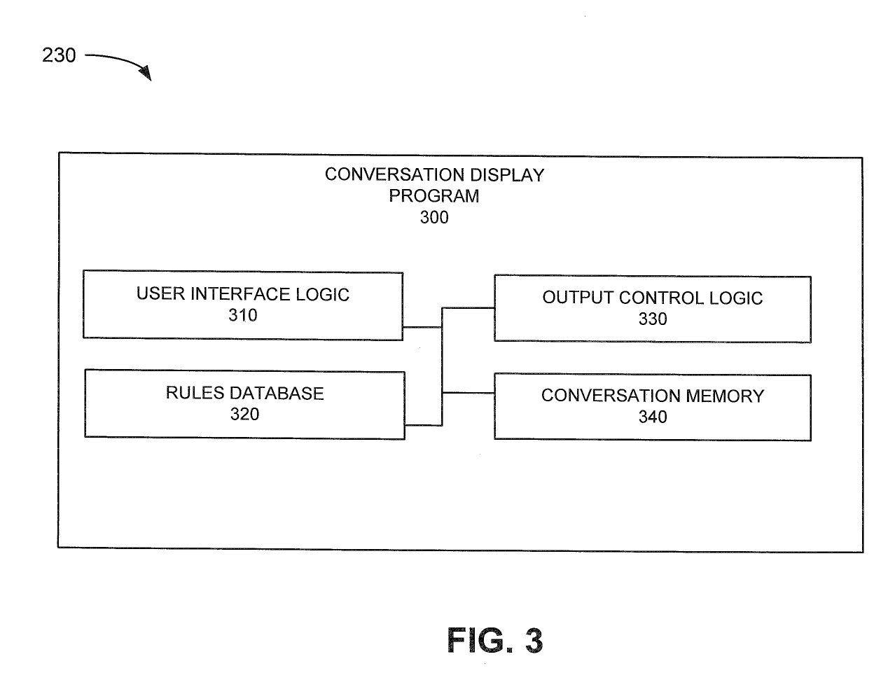

FIG. 3 is a functional block diagram of exemplary components implemented in user device 110 of FIG. 2, such as by processor 220 executing a program stored in memory. For example, referring to FIG. 3, conversation display program 300 may be stored in memory 230. Conversation display program 300 may include a software program that identifies portions of text-based or multimedia-based conversations, such as portions of email communications involving a number of parties (e.g., the parties at user devices 110-130), and displays the communications in a user-friendly format. In an exemplary implementation, conversation display program 300 may include user interface logic 310, rules database 320, output control logic 330 and conversation memory 340. Conversation display program 300 and its logic components are shown in FIG. 3 as being included in user device 110. In alternative implementations, these components or a portion of these components may be located externally with respect to user device 110. For example, in some implementations, one or more of the components of conversation display program 300 may be located in or executed by network device 140. In addition, in some implementations, each of user devices 120 and 130 may also include conversation display program 300.

User interface logic 310 may include logic that allows a user to set display-related parameters associated with text-based or multimedia-based exchanges. For example, user interface logic 310 may allow a user to select terms or phrases (e.g., names, topics, actions, dates, times, locations, etc.), that may be particularly relevant to a user. The selected terms or phrases may be highlighted in a text-based or multimedia-based conversation. User interface logic 310 may also allow a user to select portions of text-based or multimedia-based communications that will not be displayed and/or reorder portions of the communications to be displayed to the user.

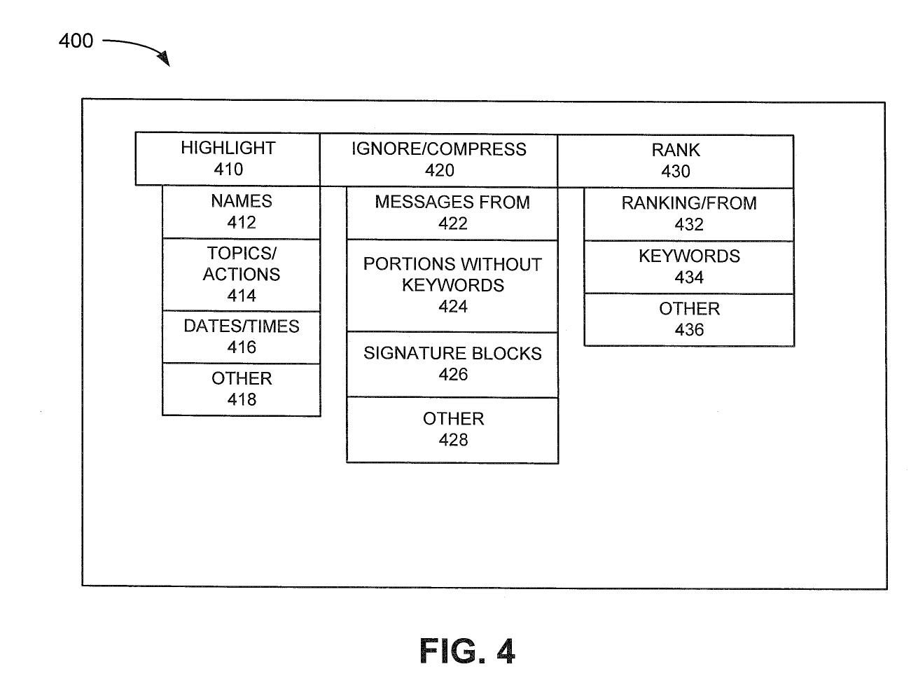

FIG. 4 illustrates an exemplary user interface provided by user interface logic 310 to a user via output device 270 (FIG. 2), such as a display associated with user device 110. Referring to FIG. 4, user interface 400 may include a menu or display that includes various items, such as highlight box 410, ignore/compress box 420 and rank box 430. Items 410-430 (also referred to herein as buttons 410-430) may be displayed as radio style buttons or input links that allow a user to select the corresponding item 410-430 and input information and/or receive further selections, such as a drop down menu with further information or selections.

For example, highlight button 410 may include sub-items, such as names button 412, topics/actions button 414, dates/times button 416 and other button 418. A user may select names button 412 and be provided with an input box or area in which the user may enter names of people that may be particularly relevant to the user. For example, the user may select names button 412 and input his/her own name, the name of his/her boss, names of co-workers, family members, etc.

Similarly, the user may select topics/actions button 414 and provide information identifying particular topics or actions that may be relevant to the user. For example, the user may provide terms and/or phrases related to the user's work functions. As an example, assume that the user is a software developer. In this case, the user many enter the terms/phrases “prototyping,” “Flash development,” “programming,” “Java,” etc., that may be particularly relevant to the user. In addition, the user may enter action-related terms, such as “meeting,” “teleconference,” and “product launch,” that may also be relevant to the user.

The user may also select dates/times button 416 and indicate that dates and times should be highlighted. In this case, the user may select dates/times box 416 and enter information, such as “all,” which may indicate that all dates/times are relevant to the user.

The user may further select other button 418 and enter other information that may be particular relevant to the user, such as locations, cities, states, addresses, telephone numbers, email addresses, IM screen names, web site uniform resource locators (URLs), etc. User interface logic 310 may store the information inputted by the user via highlight button 410, and its sub-buttons 412-418 in rules database 320.

User interface 400 may also allow the user to select how various terms/phrases entered with respect to buttons 410-418 are to be highlighted. For example, the terms/phrases inputted by the user as being relevant may be identified in a text-based communication and highlighted in a manner that is more likely to be useful for the party receiving the communication. For example, particularly relevant portions of the text-based communication may highlighted or made more prominent by bolding the terms/phrases, displaying the terms/phrases in various colors, underlining the terms/phrases, displaying the terms phrases in different fonts (e.g., italics), larger fonts, etc., to make them more prominent and quickly visible to the user. The user may select the particular type or types of highlighting to use for various terms/phrases. User interface logic 310 may store this information in rules database 320.

User interface logic 310 may also include ignore/compress button 420. The user may select this button so that portions of text-based conversations will be compressed or not displayed to the user. For example, ignore/compress button 420 may include sub-items, such as messages from button 422, portions without keywords button 424, signature blocks button 426 and other button 428. A user may select messages from button 422 and be provided with an input box or area in which the user may input names of people that may not be particularly relevant to the user. For example, the user may provide the names of various people from which messages should not be displayed, such as people who typically add little or no value to an email conversation.

The user may also select portions without keywords button 424 and provide information indicating that sentences, paragraphs and/or entire communications (e.g., emails) within a thread that do not include any keyword/phrase, such as the terms provided via buttons 410-418 should be removed or compressed and not shown when communications are displayed.

Similarly, the user may select signature blocks button 426 and indicate that signature blocks typically included at the end of an email should not be displayed to the user. For example, the user may indicate that the sending party's name, address, telephone number, fax number, confidentiality notice provided at the end of an email, etc., should not be displayed to a user. In other instances, the user may select certain portions of a signature block to be displayed, such as the user's name and telephone number, and indicate that other portions of the signature block are not to be displayed.

The user may further select other box 428 and input other information that may not be particular relevant to the user, such as email headers that include information indicating to whom the email was sent, when the email was sent, a subject of the email, parties copied on the email, etc. The information input by the user after selection of other box 428 will not be shown to the user when a communication is displayed, as described in detail below.

Rank button 430 may allow a user to rank and/or reorder various individual communications or portions of communications within a communication thread. For example, rank button 430 may include sub-items, such as a ranking/from button 432, keywords button 434 and other button 436. A user may select rankings/from button 432 and be provided with an input box or area in which a user may input names of people that may be particularly relevant to the user or information providing various criteria that is important to the user. Communications meeting these criteria may then be displayed more prominently or ranked more highly (e.g., shown earlier in a thread) to allow the user to quickly obtain the gist of a conversation.

The user may also select keywords button 434 and provide information indicating that communications with key words or terms should be ranked more highly than other communications. The user may further select other box 436 and enter other information that may be particular relevant, such as terms, phrases, etc., that may be important to the user. Conversation display program 300 may then provide individual communications within a communication thread based on information provided by the user with respect to rank button 430 and its sub-buttons 432-436 and/or provide the communications in an order based on the information provided by the user with respect to buttons 432-436, as described in detail below.

Referring back to FIG. 3, rules database 320 may include logic and rules associated with information provided by the user via user interface logic 310. For example, rules database 320 may store rules corresponding to information input via buttons 410-430 and their respective sub-items/buttons. As one example, rules database 320 may store rules that indicate that the name of the party receiving a text-based communication should be displayed using a bold font at each point in a communication thread in which the receiving party's name appears. As another example, rules database 320 may store rules associated with identifying information meeting various criteria input by the user. For example, if the user would like to highlight all telephone numbers and email addresses, rules database 320 may store rules indicating that any 7 or 10 digit string of numbers corresponds to a telephone number and that any first string of letters and/or numbers separated from a second string of letters and/or numbers by the at symbol (i.e., @) corresponds to an email address. Such rules enable output control logic 330 to parse a communication thread and identify particular user-defined items of interest.

Output control logic 330 may interact with rules database 320 to identify words and/or phrases in communications for which the user has set various parameters. Output control logic 330 may then output a communication thread, such as an email thread, for display based on the rules stored in rules database 320. For example, output control logic 330 may highlight portions of an email conversation, compress or not show other portions of an email conversation and/or reorder portions of an email conversation, as described in detail below.

Conversation memory 340 may store all or portions of communication threads received by user device 110. For example, conversation memory 340 may store complete, unedited versions of email conversations received by user device 110, as well as the edited versions displayed to the user. In some implementations, user device 110 may receive edited conversation threads that correspond to a gist of an earlier conversation involving other parties, such as parties at user devices 120 and 130. In such implementations, user device 110 may receive both the edited/gist of communication thread and the full unedited thread, when another party is looping the party at user device 110 into the thread. The complete, unedited versions may be used to expand out portions of a communication thread that are not originally displayed to the user, as described in detail below. In some implementations, the edited versions of conversations may be forwarded to other user devices when other parties are looped into the thread.

Conversation display program 300 may provide communications or portions of communications to a user in a variety of, for example, user-defined ways. This allows the user to customize and receive communications in a manner that is particularly useful or relevant, as well as allow the user to quickly respond and/or perform follow up actions regarding the conversation, as described in detail below.

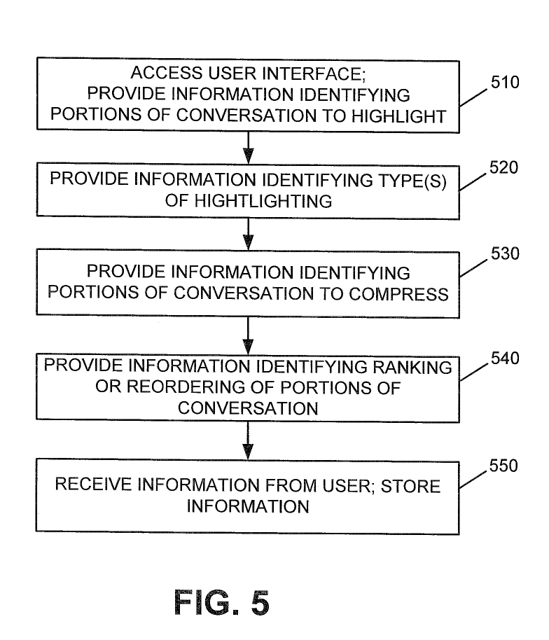

FIG. 5 is a flow diagram illustrating exemplary processing associated with selecting display-related options for communications received by user device 110. Processing may begin with a user accessing conversation display program 300. For example, the user at user device 110 may launch or open conversation display program 300 via a programs menu. Alternatively, conversation display program 300 may be part of a communication program, such as an email program. In such instances, the user may open the email/communication program to access conversation display program 300. In either case, the user may select a user settings/profile link or user interface menu. Conversation program 300 may then provide user interface 400 (act 510).

Assume that the user would like to highlight various names in an email conversation/thread, such as his/her own name. In this case, the user may select names button 412 and enter his/her own name, or “self” to indicate that his/her own name should be highlighted each time it appears in an email thread (act 510). This may be particularly useful in a long thread to allow the user to discover where his/her name first appeared in the thread and also allow the user to quickly discover why he/she is being looped into the thread. The user may also input other names, such as his/her boss's name, the names of co-workers, such as co-workers on a same team, the name of a spouse, child, etc., words such as son, daughter, mother, etc. In this case, assume that the user would like to highlight only his/her name in an email thread. User interface logic 310 may receive this information and store this information in rules database 320.

Further assume that the user would like to highlight work-related functions that may appear in an email thread. For example, assume that the user would like to highlight terms/phrases associated with his/her job, such as the terms “prototyping,” “flash development” and “launch date.” The user may select topics/action button 414 and provide the desired information to be highlighted. Further assume that the user would like to highlight various terms that relate to his/her family's activities, such as the phrases “football practice,” “dance recital,” etc. In this case, the user may select topics/actions button 414 and enter the desired information (act 510). User interface logic 310 may receive this information and store this information in rules database 320.

The user may also enter actions to be highlighted. For example, the user may select topics/actions button 414 and input the terms “meeting” and “teleconference,” so that these terms and variations (e.g., grammatical variations, abbreviations of these terms, etc.) of these terms will be highlighted in a communication thread (act 510). The user may also select dates/times button 416 to indicate that all dates and times should be highlighted and select other button 418 to provide other terms that should be highlighted.

After entering the information via buttons 412 to 418 to be highlighted, user interface 400 may request that the user provide the desired type of highlighting. For example, user interface 400 may provide a number of different highlighting options, such as bolding, use of different colored text, underlining, larger and/or different fonts, etc. The user may input the desired type of highlighting (act 520). In some implementations, the user may select different types of highlighting for various different types of information. For example, the user may indicate that his/her name should be bolded and that the information associated with topics/actions button 414 should be shown in a larger font, italicized, underlined, etc. User interface logic 310 may receive this information and store this information in rules database 320.

The user may also select ignore/compress button 420 to ignore or compress portions of a conversation that are not to be displayed. For example, the user at user device 110 may communicate with a person who typically adds little value to an email thread. In this case, the user may select messages from button 422 and input that party's name (act 530). User interface logic 310 may store this information in rules database 320. Thereafter, output control logic 330 may not show emails from that particular party within an email thread. Further assume that the user does not want to display signature blocks. In this case, the use may select signature blocks button 426 and indicate that signature blocks are not to be displayed (act 530). User interface logic 310 may receive this information and store this information in rules database 320. As discussed above, the user may also select portions without keywords button 424 and indicate that sentences, paragraphs or entire emails that do not include any keywords, such as the keywords inputted via buttons 412-418 are not to be displayed. The user may further select other button 428 to provide additional portions of the email thread (e.g., headers) that are not to be displayed.

The user may also select rank button 430 to rank various communications or portions of communications within a thread. For example, the user may wish to rank emails from his/her boss the highest within an email thread. In this case, the user may enter his/her boss's name and/or email address (act 540). The user may also provide the names of one or more parties who typically add value to an email thread as corresponding to parties from whom communications should be ranked relatively high in a communication thread. User interface logic 310 receives and stores this information in rules database 320. Output control logic 330 may then use the ranking information stored in rules database 320 to output information to the user in a manner in which higher ranked portions are displayed more prominently than other portions or higher ranked portions are displayed in a non-chronological order to allow the user to quickly see the emails from his/her boss and/or other parties that the user finds particularly relevant.

The user may also select keywords button 434 and indicate that paragraphs and/or entire emails with keywords, such as keywords associated with buttons 410-418, are to be ranked higher than other emails. This may allow the user to quickly review more relevant portions of an email thread. In each case, the information provided via user interface 400 is received by user interface logic 310 and stored in rules database 320 (act 550). Output control logic 330 may then use the information stored in rules database 320 to display received communications in the user-defined format, as described in detail below.

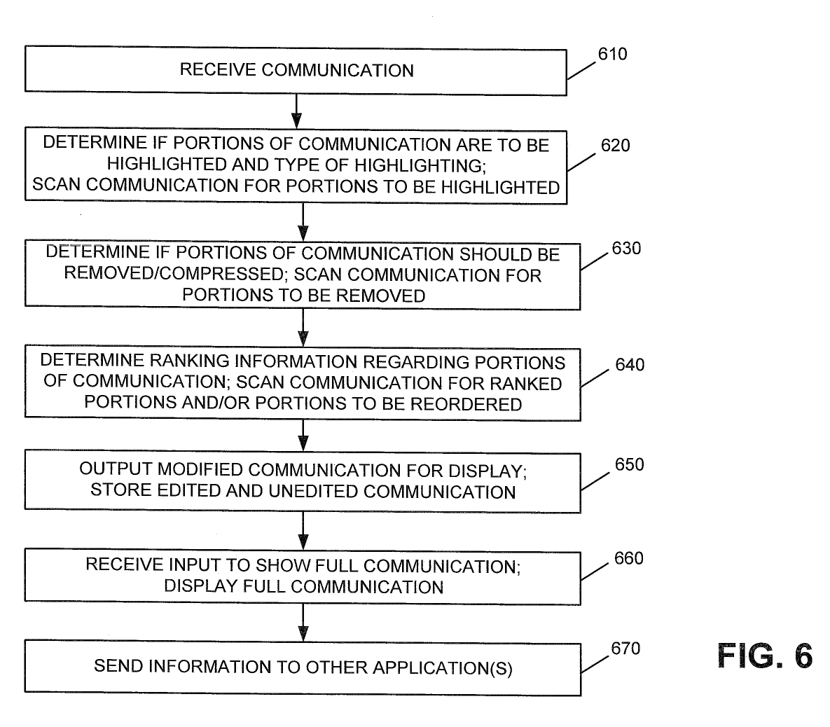

FIG. 6 illustrates processing performed by conversation display program 300 according to an exemplary implementation. Processing may begin with a text-based exchange or multimedia-based exchange involving parties at user devices 120 and 130. For example, assume that the parties at user devices 120 and 130 are exchanging several emails regarding a work-related problem. Further assume that the party at user device 120 loops the party at user device 110 into the email conversation.

Communication interface 280 of user device 110 may receive the email (act 610). Processor 220 may then access conversation display program 300 and determine how the message should be displayed.

For example, output control logic 330 may determine whether portions of the communication should be highlighted (act 620). Continuing with the example discussed above with respect to FIG. 5, output control logic 330 may access rules database 320 and determine that the user's name (i.e., the party at user device 110) should be highlighted and that the name should be highlighted via the use of bold text (act 620).

Output control logic 320 may also determine that the terms “prototyping,” “meeting” and “teleconference” should be highlighted, as described above with respect to the example in FIG. 5. Output control logic 330 may then scan the received communication, including all portions of the communication (i.e., all the emails in the email thread) to determine whether the communication includes any of the words/phrases to be highlighted (act 620).

Output control logic 320 may also determine if any portions of the email should be ignored or compressed (act 630). For example, output control logic 330 may access rules database 320 and determine that signature blocks are to be compressed or removed from the communication to be displayed. For example, as discussed above with respect to FIG. 5, the user may have selected signature blocks button 426 and indicated that signature blocks are to be removed from emails. Output control logic 330 may also determine whether emails from a particular party should be removed from a thread. For example, as discussed above, the user may have selected messages from button 422 and entered the name of one or more parties. In this case, output control logic 330 may remove emails from that party within a thread. In some instances, when an email from a party is removed from a thread, output control logic 330 may provide information indicating that the particular email has been removed, when the edited thread is provided to the user. Output control logic 330 may then scan the received communication, including all portions of the communication thread, and determine whether the communication includes any portions (e.g., sentences, paragraphs, emails, signature blocks, etc.) to be removed (act 630).

Output control logic 330 may also determine ranking information associated with portions of the communication (act 640). For example, output control logic 330 may access rules database 320 and determine whether the user has entered any information for ranking portions of the email thread. As an example, the user may have indicated that emails from his/her boss should be ranked highest and should be shown first in a displayed thread. In this case, output control logic 330 may then scan all portions of the received communication to determine whether the communication includes any communications from the user's boss that are to be reordered (act 640). In other instances, the higher ranked portions may be displayed more prominently than lower ranked portions, such as via a bold font, larger font, using asterisks before and/or after the higher ranked portions, etc.

Output control logic 330 may then output the modified or edited communication thread to output device 270, such as a display (act 650). Output control logic 330 may also store the edited and unedited communication thread in conversation memory 340 (act 650). The user may then view the communication in the user-defined manner. That is, output device 270 will display the email thread in the manner that user has defined. This allows the user to quickly obtain a gist of the conversation and identify portions that may be particularly relevant.

The user may also wish to view the entire communication. In this case, the displayed communication may include an input button or link labeled “see full thread” or similar language. The user may select this button/link (act 660). Output control logic 330 may then retrieve the full communication thread from conversation memory 340 and display the full thread, including any portions that were previously removed (act 660). In some implementations, the full communication thread may still show the highlighted portions, while in other instances, the full communication thread may be the unedited version that would typically be displayed to a user with a conventional email program.

In some instances, output control logic 330 may interact with other applications on user device 110. For example, output control logic 330 may send portions of the communication that are deemed to be more relevant, such as topic information and date and time information, to a calendar application or a notes application to store various portions of the communication thread in other applications on user device 110 (act 670). For example, if the phrase “meeting on November 4 at 10:00 AM” was identified in a communication as being relevant, output control logic 330 may send this information to a calendar application stored on user device 110. Output control logic 330 and/or the calendar application may then store this information in the 10:00 AM entry for November 4. In this manner, user device 110 may leverage information identified by conversation display program 300 as being particularly relevant for use by other applications on user device 110.

As described above, conversation display program 300 may display communications in a user-friendly format. This allows the user to easily obtain a gist of a conversation that may span several exchanges between parties involved in a thread, as opposed to laboring through long threads to attempt to obtain the information of interest, as described in more detail below.

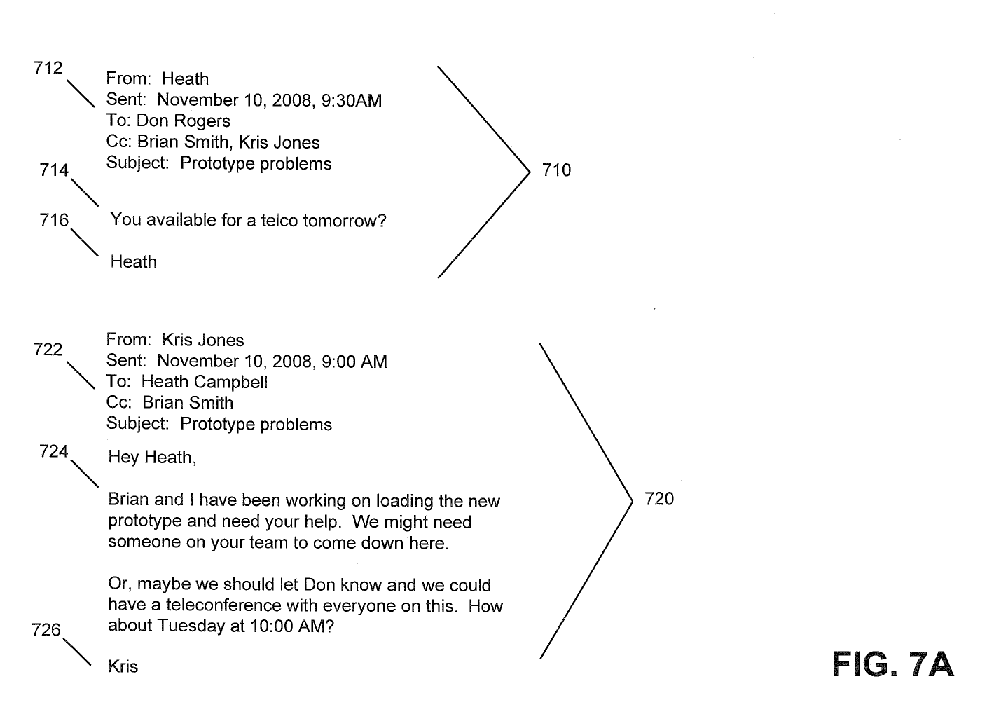

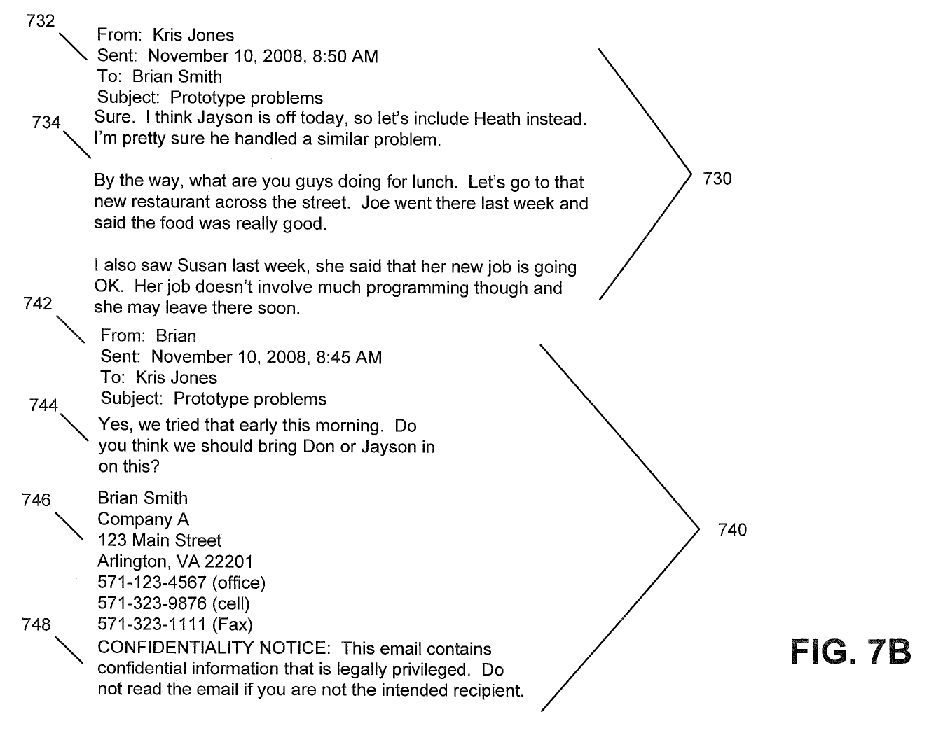

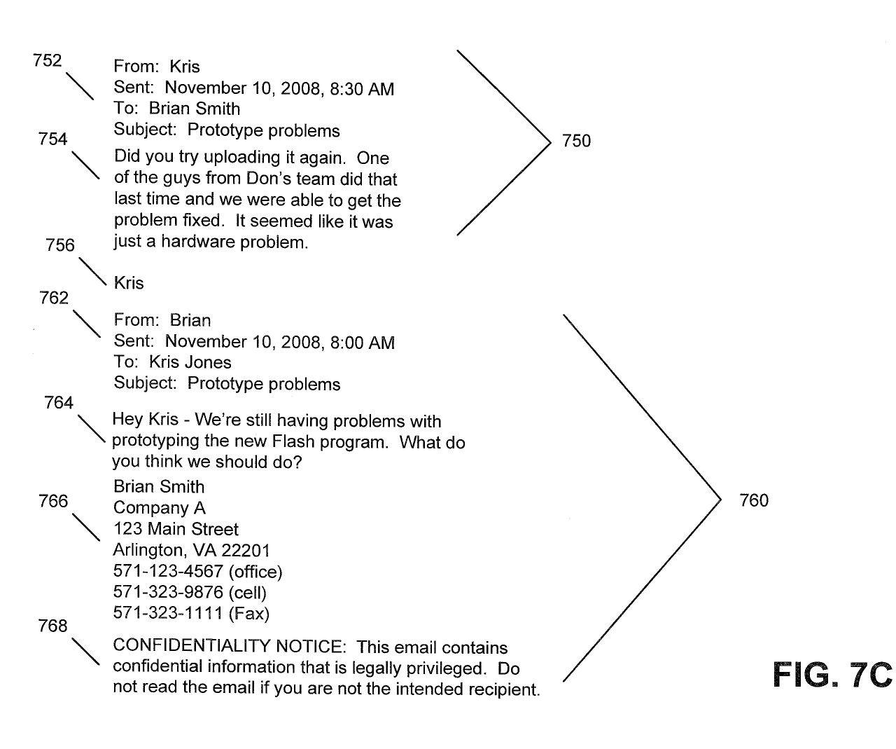

For example, FIGS. 7A-7C illustrates an exemplary output associated with a conventional email program. As illustrated, the email thread includes emails 710-760 involving a number of different parties (i.e., four in this example). In this case, Brian originally sent email 760 to Kris (FIG. 7C). Email 760 includes header 762, body 764, signature block 766 and confidentiality notice 768. Kris responded to email 760 with email 750, which includes a header 752, body 754 and signature block 756. Brian responded to email 750 with email 740 (FIG. 7B), which includes header 742, body 744, signature block 746 and confidentiality notice 748. Kris responded to email 740 with email 730, which includes header 732 and body 734. Kris also looped Heath into the conversation via email 720 (FIG. 7A) and copied Brian on email 720. Email 720 includes header 722, body 724 and signature block 726. Heath then looped Don into the conversation via email 710 and copied Brian and Kris. Email 710 includes header 712, body 714 and signature block 716.

The email conversation illustrated in FIGS. 7A-7C illustrates a typical thread that may be displayed to Don after he is looped into the earlier conversation. However, as discussed above, such email threads are typically cumbersome to go through. For example, various portions of the emails, such as the second and third paragraphs of the body of email 730 (FIG. 7B) include general conversation that may only be relevant to the receiving party and not to other parties that are looped into the conversation at later points. According to processing consistent with implementations described above, conversation display program 300 may parse an email thread and provide an edited version of the email thread to parties being looped into the conversation (i.e., Don in this example) based on information provided by a user via user interface 400.

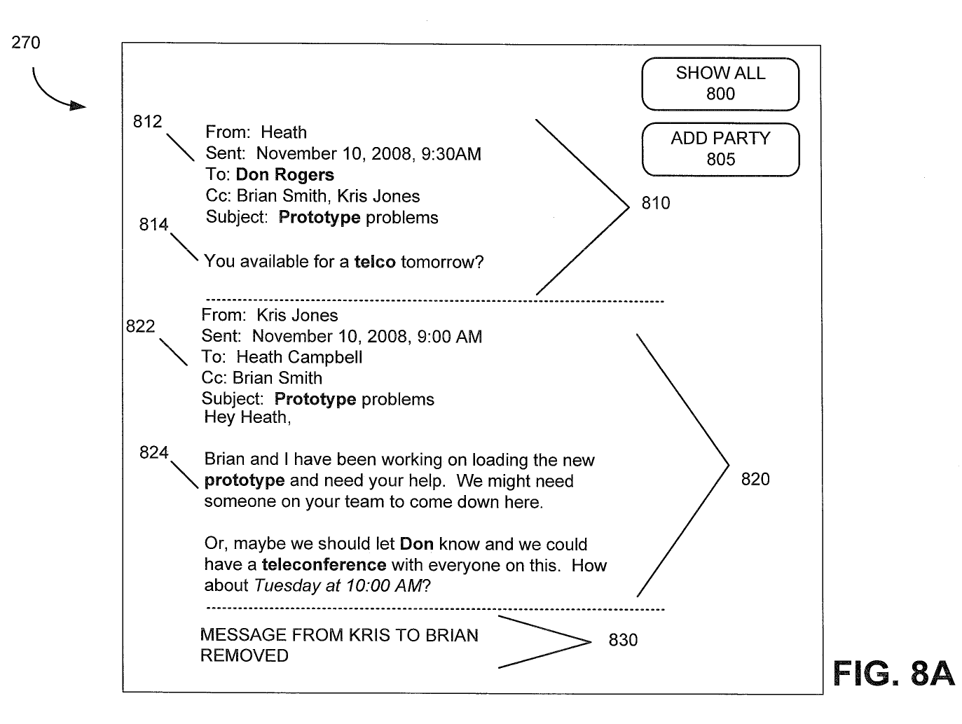

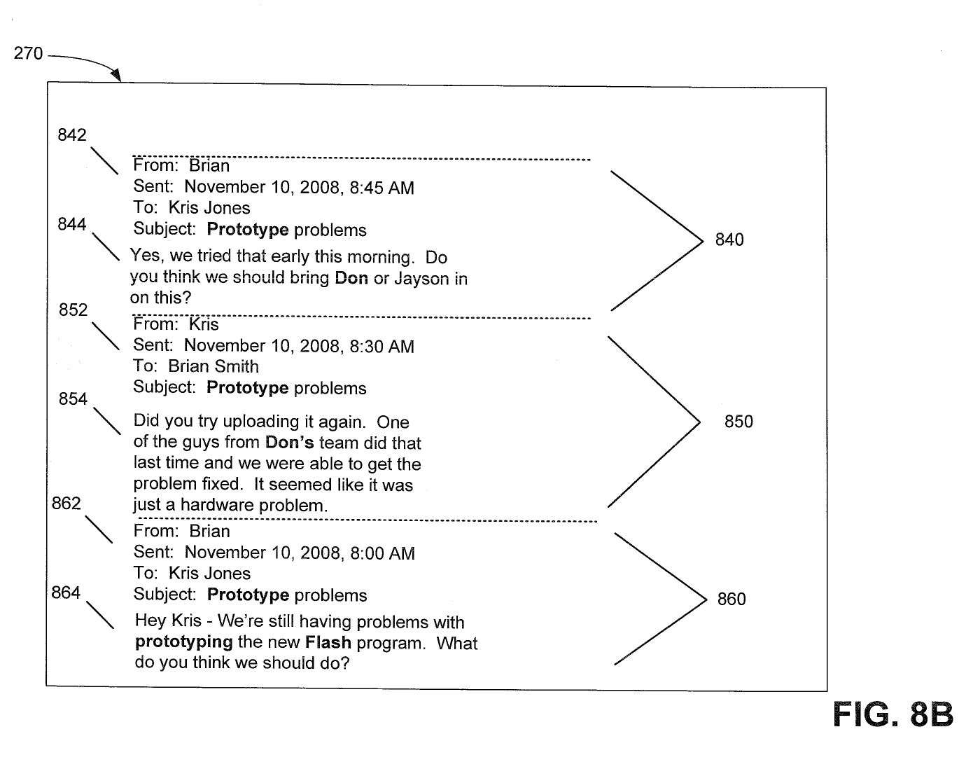

For example, FIGS. 8A and 8B illustrates an exemplary output provided by conversation display program 300 consistent with the processing described above with respect to FIGS. 3-6. Messages 810-860 correspond to messages 710-760 shown in FIGS. 7A-7C. Referring to FIG. 8B, message 860 from Brian to Kris includes header 862 and body 864. In this case, the ultimate party receiving the thread (i.e., Don in this example) has selected that the terms “prototype” and “Flash” are to be bolded and that his name is to be bolded. Don has also elected to remove signature blocks, confidentiality notices and emails that include no key words/phrases.

Referring to email 860 in FIG. 8B, the terms “prototype,” “prototyping” and “Flash” are shown in bold. In some implementations, the term “prototype” in the header of email 760 may not be bolded since the term is not included in the body of the email. In addition, the signature block and confidentiality notice (i.e., blocks 766 and 768 illustrated in FIG. 7C) are not displayed. In email 850, the term “prototype” and Don's name are bolded. In addition, the signature block (i.e., signature block 756 in FIG. 7C) is removed/not displayed. In email 840, the terms “prototype” and “Don” are bolded and the signature block and confidentiality notice (i.e., blocks 746 and 748 in FIG. 7B) are removed. In email 830, the entire email (i.e., email 730 illustrated in FIG. 7B) is removed and a brief note indicating that the email was removed is provided, as shown in FIG. 8A. In other instances, no such note is provided. In this example, email 830 include no terms/phrases in the body of email 830 that are to be highlighted, and the user at user device 110 indicated via portions without keywords button 424 that emails without any keywords/terms to be highlighted are to be removed. In email 820, the terms “prototype,” “Don,” and “teleconference” are shown in bold, and the phrase “Tuesday at 10:00 AM” is shown in italics. In this instance, the user may have provided information indicating that relevant names, topics and actions are to be bolded and dates and times are to be italicized. In addition, the signature block (i.e., block 726 in FIG. 7A) is removed. In email 810, the terms “prototype” and “telco” are bolded and the signature block (i.e., block 716 in FIG. 7A) is removed.

In this manner, conversation display program 300 outputs an edited version of the communication thread to the party being looped into the conversation (i.e., Don). This allows the party at user device 110 to quickly see where he is discussed in the thread and also allows him to see other relevant information, such as the date/time for an upcoming communication session (i.e., a teleconference in this example). Conversation display program 300 may also allow the user to quickly tab through the thread to view the highlighted portions. For example, in some implementations, the user may select the tab key or other input button to quickly jump to highlighted portions of the thread. That is, by selecting the tab key, the display may jump from one location where a term/phrase is highlighted, underlined, italicized, etc., to a next location where a relevant term is highlighted in some manner. This allows the user to quickly parse through communication threads that may run on for several pages.

In addition, the output provided in FIGS. 8A and 8B may include a show all button 800, as illustrated in FIG. 8A. The user may select show all button 800 to retrieve all portions of each email communication in the thread. For example, in response to selection of show all button 800, output control logic 330 may retrieve the entire communication thread, including portions that have been removed. In some implementations, the highlighted portions of the communication thread will remain highlighted, whereas in other implementations, the highlighted portions will not be shown with highlights. In either case, the user will be able to receive a customized gist of the conversation as illustrated in FIGS. 8A and 8B, as well as retrieve the entire unedited thread, similar to that shown in FIGS. 7A-7C.

Using conventional email programs to loop someone into a thread, typically requires that a user selects “reply all” after receiving a communication and then manually inputs a new party's email address to add the new party to add to the thread. The user then sends the thread to those parties already included in the thread and the new party. Therefore, in these conventional email program, the parties who are already included in the thread also receive the email looping in the new party. In an exemplary implementation, conversation display program 300 may include a button or link that is used to loop someone into the conversation without sending the entire thread to all of the parties in the thread.

For example, conversation display program 300 may provide an add party button 805, as illustrated in FIG. 8A. The user at user device 110 may select add party button 805 and be provided with a box to input an email address of the party to be added or a link to a contacts list/address book stored on user device 110, to allow the user to select the name/email address of the party to be added. Once the appropriate email address of the party has been entered, conversation display program 300 may forward the communication thread to the new party.

For example, assume that the party at user device 110 (i.e., Don in this example) wishes to loop Jayson into the conversation. Don may enter Jayson's email address after selecting add party button 805 and forward the communication, thread to Jayson. However, unlike conventional email programs, the other parties in the thread will not receive the communication thread when Jayson is looped into the conversation. In some implementations, after Don has looped Jayson into the conversation, the other parties in the thread (i.e., Brian, Kris and Heath in this example) will receive an indication that Jayson has been looped in the thread and may be provided with Jayson's email address. In other implementations, the other parties in the thread will not receive any indication that Jayson is looped into the thread. In either case, a party may be simply looped into a thread via add party button 805 without sending the entire thread to the parties that are already included in the thread.

In the implementations discussed above, the user at user device 110 defines various preferences associated with displaying communications threads, and conversation display program 300 outputs an edited version of the communication thread to a display. In other instances, other user devices in network 100, such as user devices 120 and 130, may include conversation display program 300 and may forward an edited communication thread to user device 110. For example, user device 120 may forward its user-defined “gist of conversation” representation or summary of a communication thread to user device 110, along with a full, unedited version of the thread. Alternatively, user device 120 may forward the unedited thread along with information that conversation display program 300 may use to edit the conversation in the manner selected or provided by the user of user device 120 (e.g., with highlighted portions, portions that are removed, etc).

In either case, user device 110 may display the thread as edited by user device 120 to allow the user of user device 110 to quickly obtain a gist of the conversation. In this instance, user device 110 may include conversation display program 300 and may optionally select a show all button, such as button 800, to display the completed, unedited version of the thread.

In still other implementations, when user device 110 receives an edited communication thread, user device 110 may further edit the thread based on the user defined preferences stored in user device 110. That is, output control logic 330 may access rules database 320 and further edit the previously edited thread to highlight, remove and/or reorder portions of the thread.

In addition, in some implementations, various parties collaborating or exchanging communications in a thread may each include conversation display program 300. For example, user devices 110, 120 and 130 may each include conversation display program 300. In some implementations, user devices 110-130 and/or the parties at user device 110 may each rank messages or snippets of messages to identify the most relevant messages/snippets. The most relevant portions may then be provided to a party being looped into the conversation at a later time, as being representative of the overall gist of the conversation or summary of the conversation.

For example, conversation display program 300 may include an algorithm to rank each communication in the thread as being relevant, less relevant, more relevant, etc. As an example, if one party is contributing a greater volume of information than other parties in a conversation, that party's contributions may be ranked higher or given more priority than other parties. As another example, if one party is not sending many communications in the thread, that party's contributions may be ranked as being less relevant. As a further example, terms/phrases that frequently appear in multiple communications in the thread may be deemed to be relevant terms/phrases and may be ranked higher than terms/phrases appearing less frequently. When the thread is forwarded to another party in network 100, the portions of the thread determined to be most relevant may be highlighted in an edited version of the thread. The algorithm used to rank portions of the conversation may also be designed to adapt or learn over time which portions should be designated as more relevant than other portions.

For example, if a communication from the party at user device 120 has resulted in quick responses from multiple parties, such as the parties at user devices 110 and 130, the contributions to the thread from the party at user device 120 may be deemed to be very relevant. In this case, conversation display program 300 may include all of the contributions from the party at user device 120 in the gist of the conversation summary. As another example, if communications from the party at user device 130 often result in follow-up communications which include terms/phrases such as “I agree,” “yes,” etc., conversation display program 300 may rank contributions from the party at user device 130 to be very relevant and include these communications in the gist of the communication thread.

In some implementations, the users themselves may rank portions of the thread as being more relevant, less relevant, etc. For example, the user may select/highlight certain snippets and select a button provided by conversation display program 300 that allows the user to indicate that these snippets are very important or relevant to the conversation. The other users may perform similar processing. When the thread is forwarded to another party, the portions designated as being most relevant may be included in the edited version/gist of the thread.

In instances when rankings associated with the ranked message differ from information stored in the user's setting/profile, output control logic 330 may dynamically update information stored in rules database 320 based on the rankings. For example, if each party in a communication thread ranks messages from the party at user device 130 very highly and rules database 320 in user device 110 does not include a similarly high ranking regarding the contributions of the party at user device 130, conversation display program 300 in user device 110 may store information in rules database 320 indicating that contributions from the party a user device 130 are highly relevant. In each case, when a user gets looped into a conversation, the gist of the conversation is customized to highlight portions that may be most relevant.

In implementations described above, a user may interact with user interface 400 to provide a user-defined profile of items that may be particularly relevant to that user. In other implementations, actions performed by the party at user device 110 may be used to create an implicit type of user profile. For example, various processing performed by user device 110 may be used to identify patterns, such as patterns that demonstrate or identify the user's skills, areas of interest, etc. In this case, conversation display program 300 may use this information gathered over time to aid in identifying terms/phrases that may be relevant to the user for highlighting in a communication thread. In other instances, reception/consumption of downloaded content (e.g., via web browsing) by the party at user device 110 and communications made over time by the party at user device 110 may be used to create an implicit user profile that may be used to identify key words/terms of interest. In still other instances, explicit information, such as a resume stored locally on user device 110, may be used to generate a more explicit user profile to aid in identifying key words/terms that may be relevant to the user. In still other instances, the implicit user profile may be captured over time by an external device, such as network device 140. In such implementations, network device 140 may be affiliated with a service provider providing, for example, Internet access.

In addition, in some implementations, network device 140 may perform all or some of the other functions described above. For example, network device 140 may store conversation display program 300 and perform the functions of conversation display program 300 described above. In such implementations, network device 140 may include a gateway or proxy device positioned between the parties involved in the conversation. In this instance, conversation data (e.g., text-based, voice-based, multimedia-based, etc.) may be captured and analyzed as it passes between the parties. Alternatively, one or more user devices 110-130 may forward conversation data to network device 140 to be captured and/or to be analyzed in near real time or at a time subsequent to the conversation. In this manner, an external device may provide the processing power to aid in displaying threads to various user devices.

Implementations described herein provide for displaying edited versions of conversations. The edited versions may provide an overview of a conversation. This may aid a party in parsing through conversation threads to ascertain a gist of earlier exchanges or a quick summary of relevant portions of the earlier exchanges. Implementations described herein also provide a simple way to link parties into a communication thread. This may also allow the user to avoid unnecessarily sending lengthy communication threads to multiple parties.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, features have been described above with respect to identifying various types of information from conversation threads involving multiple parties. In other implementations, conversation display program 300 may be used to highlight relevant portions of a communication involving a single party. For example, conversation display program 300 may be used to highlight terms/phrases in any text-based or multimedia based communication received by user device 110.

In addition, features have been described above with respect to identifying various types of information from conversation threads and displaying the information via different types of highlighting. In other implementations, other types of highlighting may be used to allow a user to easily identify potentially relevant portions of a communication thread, such as via other graphical ways or via sound or music. For example, graphical icons, emoticons, etc., may be used to highlight or draw attention to various portions of a thread. In a voice-based system, (e.g., a voicemail system), portions of a voice conversation deemed to be relevant may be played at a higher volume than other portions deemed less relevant.

Further, features have been described above as involving text-based or multimedia-based conversations. In instances when the multimedia-based conversations include voice messages, such as voice messages in a telephone call, speech recognition logic may be used to identify relevant portions of the voice-based conversations. In other instances, multimedia-based conversations may also be processed as described above. For example, for multimedia conversations, conversation display program 300 may identify pictures, videos, music files, or other multimedia files that were exchanged and scan the files and/or titles of the files to identify relevant portions of the multimedia-based exchanges. The portions deemed to have a high relevancy may then be displayed and/or output to the user in a manner that may quickly capture the attention of the user.

In addition, while series of acts have been described with respect to FIGS. 5 and 6, the order of the acts may be varied in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computer-readable medium having stored thereon sequences of instructions which, when executed by at least one processor, cause the at least one processor to:
receive information, from a user, identifying items of interest;
receive a plurality of communications comprising a communication thread;
identify at least some of the items of interest occurring in the communication thread; and
output, to a display, the communication thread with the identified at least some of the items of interest being highlighted or displayed in a different or more prominent manner than other portions of the communication thread.

2. The computer-readable medium of claim 1, further including instructions for causing the at least one processor to:
receive, from the user, information identifying portions of the communication thread that are not to be displayed; and
output, to the display, the communication thread with the identified portions removed.

3. The computer-readable medium of claim 2, further including instructions for causing the at least one processor to:
receive, from the user, an input requesting that all of the communication thread be displayed; and
output, to the display, all of the plurality of communications including the identified portions that were previously removed.

4. The computer-readable medium of claim 1, wherein when identifying at least some of the items of interest, the instructions cause the at least one processor to:
identify at least one of a name of the user or a word or phrase associated with a topic associated with the user.

5. The computer-readable medium of claim 4, wherein when identifying at least some of the items of interest, the instructions further cause the at least one processor to:
highlight information associated with a subsequent meeting or subsequent communication session.

6. The computer-readable medium of claim 5, further including instructions for causing the at least one processor to:
forward the information associated with the subsequent meeting to a calendar application stored on a device associated with the display.

7. The computer-readable medium of claim 1, wherein the communication thread comprises a text-based or multimedia-based thread involving a plurality of different parties.

8. The computer-readable medium of claim 1, wherein the communication thread includes a plurality of email messages edited by at least one user device involved in at least one of sending or receiving one of the plurality of email messages, and wherein when outputting the communication thread, the instructions cause the at least one processor to:
output an edited version of the plurality of email messages based on ranking or relevance information provided via the at least one user device.

9. The computer-readable medium of claim 1, wherein the communication thread includes a plurality of email messages edited via at least one user device involved in at least one of sending or receiving one of the plurality of email messages, the computer-readable medium further including instructions for causing the at least one processor to:
re-edit the plurality of email messages based on user-defined preference information; and
output, to the display, the re-edited plurality of email messages.

10. The computer-readable medium of claim 1, further including instructions for causing the at least one processor to:
store the received communication thread in a memory; and
store, in the memory, an edited version of the communication thread that is output to the display.

11. The computer-readable medium of claim 10, further including instructions for causing the at least one processor to:
forward the edited version of the communication thread to another device associated with a party being looped into the communication thread.

12. The computer-readable medium of claim 1, further including instructions for causing the at least one processor to:
receive an edited version of a second communication thread via a network; and
automatically modify the edited version of the second communication thread based on user defined preference information or a user profile.

13. The computer-readable medium of claim 1, wherein the communication thread includes a plurality of email messages involving a first plurality of parties, the computer-readable medium further including instructions for causing the at least one processor to:
receive, from the user, a selection requesting that an other party be looped or linked into the communication thread; and
automatically forward the communication thread to the other party without forwarding the communication thread to each of the first plurality of parties, in response to the selection.

14. The computer-readable medium of claim 13, further including instructions for causing the at least one processor to:
send a notification to the first plurality of parties indicating that the other party is looped or linked into the thread.

15. A method, comprising:
receiving, by a first user device, a plurality of communications comprising a communication thread;
identifying, by the first user device, at least some items of interest in the communication thread; and
displaying, by the first user device, the communication thread with the identified at least some of the items of interest being highlighted or displayed in a different manner than other portions of the communication thread.

16. The method of claim 15, further comprising:
removing or deleting first portions of the communication thread, prior to displaying the communication thread, based on a ranking or relevancy determination associated with the first portions.

17. The method of claim 15, wherein the identifying at least some of the items of interest comprises identifying at least one of a name of the user associated with the first user device or a function associated with a user of the first user device.

18. The method of claim 15, wherein the communication thread includes a plurality of email messages edited by at least a second user device involved in at least one of sending or receiving one of the plurality of email messages, and wherein the displaying the communication thread comprises:
displaying an edited version of the plurality of email messages based on ranking or relevance information provided via the at least second user device.

19. The method of claim 18, wherein the displaying an edited version comprises:
automatically modifying the edited version, prior to displaying the edited version, based on user defined preference information or a user profile.

20. The method of claim 15, wherein the communication thread includes a plurality of communications involving a first plurality of parties, the method further comprising:
receiving, via the first user device, a selection requesting that another party be looped or linked into the communication thread;
automatically forwarding the communication thread to the other party without forwarding the communication thread to each of the first plurality of parties, in response to the selection; and
sending a notification to the first plurality of parties that the other party is looped or linked into the thread.

21. The method of claim 20, wherein the automatically forwarding comprises:
forwarding information that allows the other party to display an unedited version of the communication thread and an edited version of the communication thread.

22. A device, comprising:
a communication interface configured to send and receive communications;
a display; and
logic configured to:
receive a communication thread via the communication interface,
identify at least some items of interest in the communication thread based on ranking or relevancy information provided by at least one of a user of the device, other parties associated with the communication thread, or other devices associated with the communication thread, and
output, to the display, the communication thread with the identified at least some of the items of interest being highlighted or displayed in a different manner than other portions of the communication thread.

23. The device of claim 22, wherein the logic is further configured to:
identify portions of the communication thread to remove, prior to outputting the communication thread to the display, based on the ranking or relevancy information.

24. The device of claim 22, wherein when identifying at least some items of interest, the logic is configured to identify at least two of a name of the user, a word or phrase associated with a function performed by the user, or a word or phrase associated with a subsequent meeting or subsequent communication session.

25. The device of claim 22, wherein the communication thread comprises a multimedia-based communication thread which includes one of at least image, video or voice data.
